(19) United States
(12) Patent Application Publication
(10) Pub. No.: US 2013/0139504 A1
(43) Pub. Date: Jun. 6, 2013

(54) EXAHUST SYSTEM AND METHOD FOR CONTROLLING TEMPERATURE OF EXHAUST GAS

(71) Applicant: Patrick Barasa, Ann Arbor, MI (US)

(72) Inventor: Patrick Barasa, Ann Arbor, MI (US)

(73) Assignee: GM GLOBAL TECHNOLOGY OPERATIONS LLC, Detroit, MI (US)

(21) Appl. No.: 13/309,291

(22) Filed: Dec. 1, 2011

(51) Int. Cl. F01N 3/18; F02C 6/12; F02D 41/14

(52) U.S. Cl. 60/605.1; 123/676; 60/274; 60/285

(57) ABSTRACT

In one exemplary embodiment of the invention, a method for controlling exhaust gas temperature in an exhaust system includes determining a flow rate of an exhaust gas received by the exhaust system, determining a temperature of the exhaust gas and determining a specific heat for the exhaust gas. The method also includes determining an amount of energy required to attain a desired temperature for the exhaust gas entering an exhaust device, wherein the amount of energy is based on the determined flow rate, temperature and specific heat for the exhaust gas and communicating a signal to control at least one of a fuel flow rate or an air flow rate based on the determined amount of energy.

### FIELD OF THE INVENTION

The subject invention relates to exhaust systems and, more specifically, to methods and systems for controlling exhaust gas temperature at one or more selected locations in exhaust systems.

### BACKGROUND

An engine control module of an internal combustion engine controls the mixture of fuel and air supplied to combustion chambers within cylinders of the engine. After the air/fuel mixture is ignited, combustion takes place and later the combustion gases exit the combustion chambers through exhaust valves. The combustion gases are directed by an exhaust manifold to a catalytic converter or other components of an exhaust aftertreatment system. Some engines optionally may include a forced air induction device, such as a turbocharger, that is positioned between the exhaust manifold and exhaust aftertreatment components.

Manufacturers of internal combustion engines, particularly diesel engines, are presented with the challenging task of complying with current and future emission standards for the release of nitrogen oxides, particularly nitrogen monoxide, as well as unburned and partially oxidized hydrocarbons, carbon monoxide, particulate matter, and other particulates. In order to reduce the emissions of internal combustion engines, an exhaust aftertreatment system is used to reduce particulates from the exhaust gas flowing from the engine.

Exhaust gas aftertreatment systems typically include one or more aftertreatment devices, such as particulate filters, catalytic converters, mixing elements and urea/fuel injectors. Control of temperature of the exhaust gas flowing in the system can affect the performance of exhaust system components. For example, an oxidation catalyst may take a selected amount of time after the engine starts to reach its “light-off” or operating temperature. The light-off temperature is the temperature at which the component effectively and efficiently alters exhaust gas constituents or removes the desired particulates from the exhaust gas. Control of the exhaust gas temperature at selected locations in the exhaust system depends on system components and their configuration. Testing each system configuration is used to determine correlation between inputs, such as fuel or air flow rates, and exhaust gas temperatures. Thus, variations in exhaust systems and components may lead to significant testing and data logging which is then used to determine and control exhaust gas temperatures at selected locations.

### SUMMARY OF THE INVENTION

In one exemplary embodiment of the invention, a method for controlling exhaust gas temperature in an exhaust system includes determining a flow rate of an exhaust gas received by the exhaust system, determining a temperature of the exhaust gas and determining a specific heat for the exhaust gas. The method also includes determining an amount of energy required to attain a desired temperature for the exhaust gas entering an exhaust device, wherein the amount of energy is based on the determined flow rate, temperature and specific heat for the exhaust gas and communicating a signal to control at least one of a fuel flow rate or an air flow rate based on the determined amount of energy.

In another exemplary embodiment of the invention, a system for controlling exhaust gas temperature includes a conduit configured to receive an exhaust gas from a turbocharger, wherein the exhaust gas flows at a flow rate, a temperature sensor configured to determine a temperature of the exhaust gas and a controller configured to determine an amount of energy required to attain a desired temperature for the exhaust gas entering an exhaust device, wherein the amount of energy is based on the flow rate, temperature and a specific heat for the exhaust gas. The system also includes a first valve configured to receive a signal from the controller and control at least one of a fuel flow rate or an air flow rate based on the determined amount of energy.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a diagram of an exemplary internal combustion engine and associated exhaust aftertreatment system; and

FIG. 2 is diagram of an exemplary method and system for determining the amount of energy to attain a desired temperature at a selected location in an exhaust system.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein the term controller or control module refers to an application specific integrated circuit (ASIC), an electronic circuit, a processor (shared, dedicated or group) and memory that executes one or more software or firmware programs, a combinational logic circuit, and/or other suitable components that provide the described functionality.

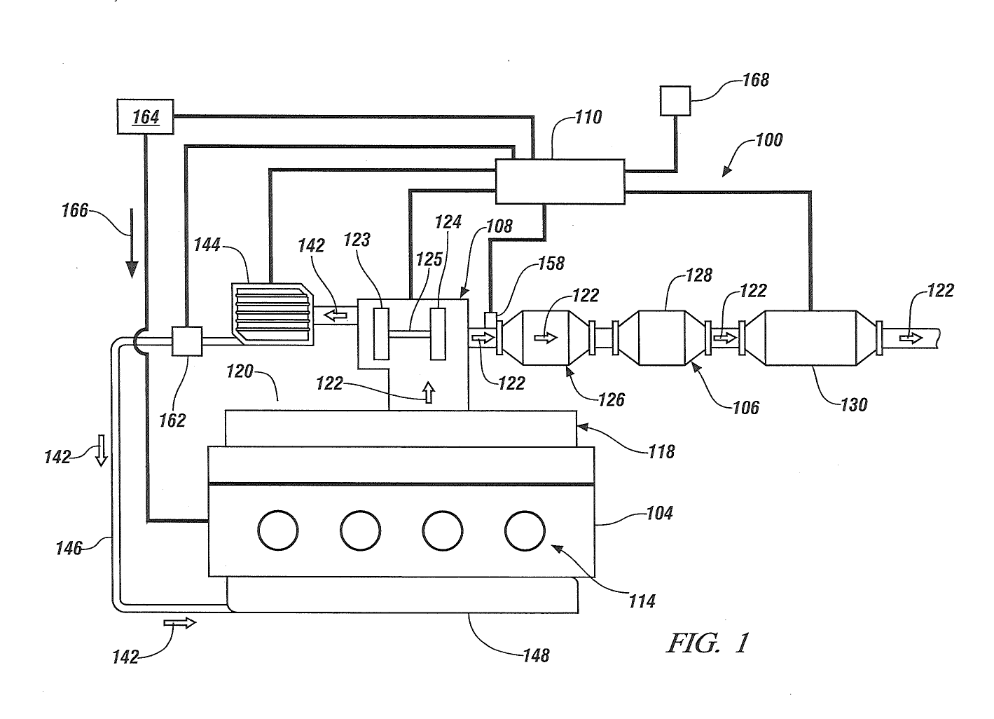

In accordance with an exemplary embodiment of the invention, FIG. 1 illustrates an exemplary internal combustion engine 100, in this case an in-line four cylinder engine, including an engine block and cylinder head assembly 104, an exhaust system 106, a turbocharger 108 and a control module 110 (also referred to as a “controller”). The internal combustion engine 100 may be a diesel engine or a spark ignition engine. Coupled to the engine block and cylinder head assembly 104 is an exhaust manifold 118. In addition, the engine block and cylinder head assembly 104 includes cylinders 114 wherein the cylinders 114 receive a combination of combustion air and fuel supplied from a fuel system 164. The combustion air/fuel mixture is combusted resulting in reciprocation of pistons (not shown) located in the cylinders 114. The reciprocation of the pistons rotates a crankshaft (not shown) to deliver motive power to a vehicle powertrain (not shown) or to a generator or other stationary recipient of such power (not shown) in the case of a stationary application of the internal combustion engine 100. The combustion of the air/fuel mixture causes a flow of exhaust gas through the exhaust manifold 118 and turbocharger 108 and into the exhaust system 106. In an embodiment, the turbocharger 108 includes a compressor wheel 123 and a turbine wheel 124 coupled by a shaft 125 rotatably disposed in the turbocharger 108.

An exhaust gas flow 122 resulting from combustion within cylinders 114 drives the turbine wheel 124 of turbocharger 108, thereby providing energy to rotate the compressor wheel 123 to create a compressed air charge 142 while the exhaust gas 122 flows from the turbocharger 108 to an oxidation catalyst (“OC”) 126. In an exemplary embodiment, the compressed air charge 142 is cooled by a charge cooler 144 and is routed through a flow control device, such as a valve 162, and a conduit 146 to an intake manifold 148. The valve 162 is coupled to the controller 110 and controls a flow rate (e.g., mass flow rate, g/s) of the compressed air charge 142. The compressed air charge 142 provides additional combustion air (when compared to a non-turbocharged, normally aspirated engine) for combustion with fuel in the cylinders 114, thereby improving the power output and efficiency of the internal combustion engine 100.

The exhaust gas 122 flows through the exhaust system 106 for the removal or reduction of particulates and is then released into the atmosphere. The exhaust system 106 may include catalysts, such as the OC 126 and selective catalytic reduction (“SCR”) device 128, as well as a particulate filter (“PF”) 130. The OC 126 may include, for example, a flow-through metal or ceramic monolith substrate that is wrapped in an intumescent mat or other suitable support that expands when heated, securing and insulating the substrate. The substrate may be packaged in a stainless steel shell or canister having an inlet and an outlet in fluid communication with exhaust gas conduits or passages. An oxidation catalyst compound may be applied as a wash coat and may contain platinum group metals such as platinum (Pt), palladium (Pd), rhodium (Rh) or other suitable oxidizing catalysts. The SCR device 128 may also include, for example, a flow-through ceramic or metal monolith substrate that is wrapped in an intumescent mat or other suitable support that expands when heated, securing and insulating the substrate. The substrate may be packaged in a stainless steel shell or canister having an inlet and an outlet in fluid communication with exhaust gas conduits. The substrate can include an SCR catalyst composition applied thereto. The SCR catalyst composition may contain a zeolite and one or more base metal components such as iron (Fe), cobalt (Co), copper (Cu) or vanadium which can operate efficiently to convert NOx constituents in the exhaust gas 122 in the presence of a reductant such as ammonia (NH₃). An NH₃ reductant may be supplied from a fluid supply (reductant supply) and may be injected into the exhaust gas 122 at a location upstream of the SCR device 128. The reductant may be in the form of a gas, a liquid, or an aqueous urea solution and may be mixed with air in the injector to aid in the dispersion of the injected spray.

The particulate filter (PF) 130 may be disposed downstream of the SCR device 128. The PF 130 operates to filter the exhaust gas 122 of carbon and other particulates. In embodiments, the PF 130 may be constructed using a ceramic wall flow monolith filter that is wrapped in an intumescent mat or other suitable support that expands when heated, securing and insulating the filter. The filter may be packaged in a shell or canister that is, for example, stainless steel, and that has an inlet and an outlet in fluid communication with exhaust gas conduits. The ceramic wall flow monolith filter may have a plurality of longitudinally extending passages that are defined by longitudinally extending walls. The passages include a subset of inlet passages that have and open inlet end and a closed outlet end, and a subset of outlet passages that have a closed inlet end and an open outlet end. Exhaust gas 122 entering the filter through the inlet ends of the inlet passages is forced to migrate through adjacent longitudinally extending walls to the outlet passages. It is through this exemplary wall flow mechanism that the exhaust gas 122 is filtered of carbon (soot) and other particulates. The filtered particulates are deposited on the longitudinally extending walls of the inlet passages and, over time, will have the effect of increasing the exhaust gas backpressure experienced by the internal combustion engine 100. The accumulation of particulate matter within the PF 130 is periodically cleaned, or regenerated to reduce backpressure. It should be understood that the ceramic wall flow monolith filter is merely exemplary in nature and that the PF 130 may include other filter devices such as wound or packed fiber filters, open cell foams, sintered metal fibers, etc. The OC 126, SCR device 128 and PF 130 may each have a selected operating temperature (also referred to as “light-off” temperature) at which the device effectively and efficiently removes particulates or alters the exhaust gas. For example, the SCR device 128 has an operating temperature for exhaust gas received at which the device converts NO to NO₂ at or above the selected temperature. In addition, the OC 126 may be used to combust hydrocarbon (“HC”) in an exothermic reaction that is effective to combust particulates to regenerate the accumulated particulates in the PF 130. Initiation of the PF 130 regeneration typically occurs at a selected light-off or operating temperature, wherein the exothermic reaction causes the exhaust gas 122 temperature to attain the light-off temperature.

In an exemplary internal combustion engine 100, the control module 110 is in signal communication with the turbocharger 108, the charge cooler 144, the fuel system 164, sensors 158 and 168, and the exhaust system 106, wherein the control module 110 is configured to use various signal inputs to control various processes. In embodiments, the control module 110 is configured to receive signal inputs from sensors 158 and 168 that includes information, such as temperature (intake system, exhaust system, engine coolant, ambient, etc.), pressure, exhaust flow rates, soot levels, NOx concentrations, exhaust gas constituencies (chemical composition) and other parameters. The control module 110 is configured to perform selected processes or operations based on the sensed parameters, such as controlling a flow rate of fuel 166 and/or a flow rate of air (compressed air charge 142) based on an energy required to attain a desired or target temperature for the exhaust gas 122 entering the OC 126. In embodiments, the controller 110 determines the energy required based on determinations of exhaust gas 122 temperature and flow rate. The exemplary sensor 158 is positioned proximate an inlet of the OC 126 and may include one or more sensors to determine exhaust gas parameters, including flow rate and temperature. Exhaust gas temperatures and flow rates may be determined by any suitable method, such as modeling, equations and/or sensor measurements.

In embodiments, the OC 126, SCR device 128 and PF 130 treat exhaust gas (i.e., removes particulates or alter exhaust make-up) more effectively at selected temperatures. Specifically, the exhaust gas 122 entering the SCR device 128 treats the exhaust most effectively at a temperature that the oxidation catalyst compound on the substrate is able to convert the NO to NO₂ in the exhaust gas. In an embodiment, the arrangement also enables improved temperature control of the exhaust gas 122 flowing into SCR device 128 and PF 130 downstream of the OC 126, and improved performance of those components. Accordingly, the depicted system and method improve control of the exhaust gas temperature at various locations in the exhaust system 106 to improve exhaust treatment and efficiency. It should be noted that the arrangement of the exhaust system devices may vary, where the devices include the OC 126, SCR device 128 and PF 130. In addition, other devices may be includes in the system in addition to the depicted devices, while some of the depicted exhaust devices may be removed in some embodiments. The exemplary method and system enable improved control of exhaust gas temperature for various exhaust system configurations. For example, in some embodiments, the method is used to first determine exhaust gas temperature entering the OC 126. In other embodiments, the method is used to first determine exhaust gas temperature entering the SCR device 128, wherein the system does not include the OC 126.

In an embodiment, the controller 110 uses the following time-based equation to determine the amount of energy required to attain the desired or target temperature,

$$E ( t ) = {mC}_{P} [ ( \frac{d T}{d t} ) t {e}^{- α t} + ( {T}_{ctl} - {T}_{act} ) {e}^{- α t} ] , \\ where$$

$$α = \frac{R}{2 L}$$

and E(t)=energy to attain the target temperature, m=exhaust mass flow rate, C_{P}=exhaust specific heat, T_{ctl}=target temperature, T_{act}=measured temperature, R=exhaust mass flow rate X exhaust specific heat, L=mass of the components that absorb heat (i.e., turbocharger housing, exhaust manifold) X specific heat of those components.

The corresponding mass flow rate for air and fuel for the determined energy are described by the following equation,

$${m}_{air} = \frac{E ( t )}{{C}_{Pair} \cdot {T}_{air}}$$

$$and$$

$${m}_{fuel} = \frac{E ( t )}{L H {V}_{fuel}}$$

wherein m=change mass flow rate of air or fuel, Cₚₐᵢᵣ=specific heat capacity of air, Tₐᵢᵣ=ambient air temperature and LHV_{fuel}=lower heating value of fuel.

In an embodiment, the exhaust gas flow rate is determined by a sensor measurement while the specific heat values are known values. In one embodiment, the specific heat values may be determined using measured values in addition to known values The temperature values refer to the measured or target temperatures at the desired location, such as proximate an inlet of the OC 126. The ambient air temperature may be determined by the sensor 168, while the lower heating value of fuel is a known value for diesel fuel.

In embodiments, the changes in mass flow rate for air and/or fuel may be balanced or allocated based on efficiency or other factors (i.e., emissions etc.). For example, the fuel flow rate and air flow rate may each be changed to provide the most efficient use of available energy in the engine system. In one embodiment, the energy to be provided may be provided by a change in mass flow rate for only one parameter (i.e., only changing air or fuel mass flow). In another embodiment, a fraction, such as half of the energy required for the target temperature, is provided by air mass flow rate adjustments while the other half is provided by fuel mass flow rate adjustments. In the example, the numerator value for each mass flow equation (“E(t)”) is multiplied by 0.5. Accordingly, the proportion of the required energy to be contributed by fuel and/or air mass flow rate may be adjusted based on one or more factors, including energy conservation, balance and efficiency. The depicted arrangement provides a flexible system and method for balancing energy contributions from fuel and air flows to attain a desired temperature at selected locations in the exhaust system. The arrangement enables a controller to adjust the air or fuel flow rates to control exhaust gas temperature while also accounting for variations in system configuration and components. In other exhaust system embodiments, extensive testing and calibration is used to provide data used to map flow rates to exhaust temperatures. Alterations to system components or configurations can lead to time spent performing lengthy tests for data logging. Thus, the embodiment does not provide flexibility for exhaust gas temperature control across several applications (i.e., different vehicles) or during changes to the exhaust system.

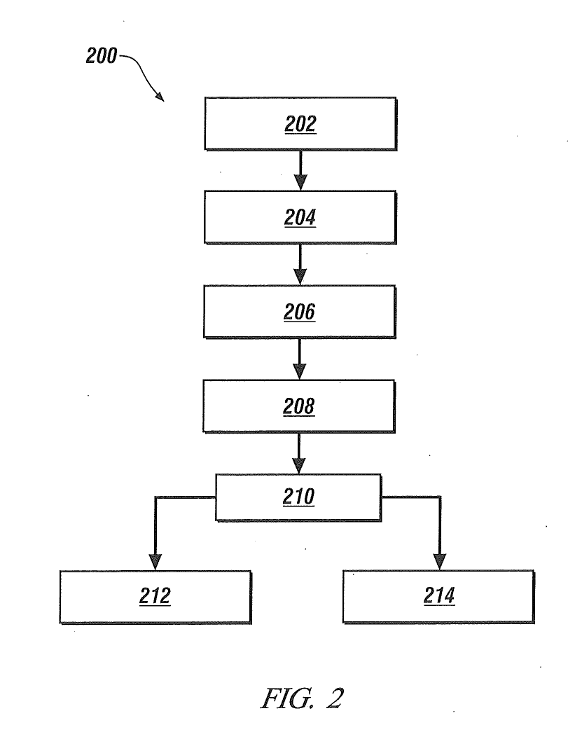

FIG. 2 is a diagram 200 of an exemplary method and system for determining the amount of energy required to attain a desired temperature at a selected location in an exhaust system. In an embodiment, the method is used to determine energy required to attain a desired exhaust gas temperature received by the OC 126 (FIG. 1). In block 202, a flow rate for the exhaust gas 122 received by the exhaust system is determined. The flow rate may be determined by any suitable method, such as a measurement by the sensor 158 proximate an inlet of the OC 126. In block 204, an exhaust gas temperature at the selected location, such as proximate the OC 126 inlet, is determined by a suitable method, such as a measurement by sensor 158. In block 206, a specific heat for the exhaust gas 122 is determined. The specific heat may be a known value based on values in a look up table. The specific heat determination may also use measurements of exhaust constituents to determine the specific heat.

In block 208, the amount of energy required to attain the desired (or target) temperature for the exhaust gas 122 at a selected location is determined. The energy may be determined based on an equation with known inputs and measured inputs, such as the equation discussed above. In block 210, the determined amount of energy is used to determine corresponding adjustments in air mass flow rate and/or fuel mass flow rate. The amount of energy to be provided may be divided or balanced between changes in air mass flow rate and/or fuel mass flow rate based on several factors, such as efficiency or available fuel/air. In block 212, a command is sent to control the air flow rate, wherein the command causes the change in mass air flow rate determined in block 210 to provide the required energy. The command may be a signal to control a flow control device in an air flow circuit. In block 214, a command is sent to control the fuel flow rate, wherein the command causes the change in mass fuel flow rate determined in block 210 to provide the required energy. In an embodiment, the command may be a signal to control a flow control device in a fuel system 164.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method for controlling exhaust gas temperature in an exhaust system, the method comprising:
determining a flow rate of an exhaust gas received by the exhaust system;
determining a temperature of the exhaust gas;
determining a specific heat for the exhaust gas;
determining an amount of energy required to attain a desired temperature for the exhaust gas entering an exhaust device, wherein the amount of energy is based on the determined flow rate, temperature and specific heat for the exhaust gas; and
communicating a signal to control at least one of a fuel flow rate or an air flow rate based on the determined amount of energy.

2. The method of claim 1, wherein determining the flow rate of the exhaust gas comprises measuring the flow rate.

3. The method of claim 1, wherein determining the temperature of the exhaust gas comprises measuring the temperature.

4. The method of claim 1, wherein the desired temperature comprises a temperature at which the oxidation catalyst effectively removes particulates.

5. The method of claim 1, wherein communicating the signal comprises communicating a first signal to control the fuel flow rate and communicating a second signal to control the air flow rate.

6. The method of claim 5, wherein the fuel flow rate and air flow rate are balanced to provide an efficient addition of energy.

7. The method of claim 1, wherein the exhaust device comprises an oxidation catalyst.

8. A system for controlling exhaust gas temperature, the system comprising:
a conduit configured to receive an exhaust gas from a turbocharger, wherein the exhaust gas flows at a flow rate;
a temperature sensor configured to determine a temperature of the exhaust gas;
a controller configured to determine an amount of energy required to attain a desired temperature for the exhaust gas entering an exhaust device, wherein the amount of energy is based on the flow rate, temperature and a specific heat for the exhaust gas; and
a first valve configured to receive a signal from the controller and control at least one of a fuel flow rate or an air flow rate based on the determined amount of energy.

9. The system of claim 8, comprising a flow rate sensor configured to determine the flow rate of the exhaust gas.

10. The system of claim 8, wherein the exhaust device comprises an oxidation catalyst.

11. The system of claim 10, wherein the desired temperature comprises a temperature at which the oxidation catalyst effectively combusts particulates in a particulate filter.

12. The system of claim 8, comprising a second valve configured to control the air flow rate, wherein the first valve is configured to control the fuel flow rate, and wherein the controller is configured to communicate signals to control the first and second valves.

13. The system of claim 12, wherein the fuel flow rate and air flow rate are balanced to provide an efficient addition of energy.

14. A vehicle comprising:
a turbocharger configured to receive exhaust gas from an engine,
an exhaust device configured to receive exhaust gas from the turbocharger
a flow rate sensor configured to determine a flow rate of the exhaust gas entering the exhaust device;
a temperature sensor configured to determine a temperature of the exhaust gas entering the exhaust device;
a controller configured to determine an amount of energy required to attain a desired temperature for the exhaust gas entering the exhaust device, wherein the amount of energy is based on the flow rate, temperature and a specific heat for the exhaust gas; and
a first valve configured to receive a signal from the controller and control at least one of a fuel flow rate or an air flow rate based on the determined amount of energy.

15. The vehicle of claim 14, wherein the exhaust device comprises an oxidation catalyst.

16. The vehicle of claim 15, wherein the desired temperature comprises a temperature at which the oxidation catalyst effectively combusts particulates in a particulate filter.

17. The vehicle of claim 14, comprising a second valve configured to control the air flow rate, wherein the first valve is configured to control the fuel flow rate, and wherein the controller is configured to communicate signals to control the first and second valves.

18. The vehicle of claim 17, wherein the fuel flow rate and air flow rate are balanced to provide an efficient addition of energy.
